(19) United States
(12) Patent Application Publication
(10) Pub. No.: US 2011/0177219 A1
(43) Pub. Date: Jul. 21, 2011

(54) Method, System and Apparatus for Removing Impurities From Wine

(75) Inventors: Robert G. Roodman, Ellwood City, PA (US); J. Michael Havelka, Sewickley, PA (US); Jack D. Smiley, Monaca, PA (US)

(73) Assignee: Vinterus Technologies LLC, Sewickley, PA (US)

(21) Appl. No.: 13/076,753

(22) Filed: Mar. 31, 2011

Related U.S. Application Data
(63) Continuation of application No. 10/554,451, filed on Dec. 12, 2007.
(60) Provisional application No. 60/511,618, filed on Oct. 15, 2003.
(60) Provisional application No. 60/466,643, filed on Apr. 30, 2003.

(51) Int. Cl. B01D 35/02; B01D 37/00; C12G 1/00; B01D 15/00

(52) U.S. Cl. 426/422; 426/495; 210/473; 210/416.1; 210/263; 210/291

(57) ABSTRACT

An impurity removal system for purifying wine removable from a wine source. The system includes a filtered wine container defined by a collection portion and having an opening for introducing the wine to the collection portion filtration device which is in operable communication between the wine source and the container, such that at least a portion of the wine introduced from the wine source is in fluid communication with the filtration device prior to collection in the collection portion of the filtered wine container. In operation, the wine is removed from the wine source, introduced to the system, passed through the filtration device and filtered wine flows into the collection portion of the filtered wine container. Vacuum-based and pressure-based filtration systems are also disclosed, as well as a method of removing impurities from wine.

### CROSS REFERENCE TO RELATED APPLICATIONS

This application is a continuation of U.S. patent application Ser. No. 10/554,451 filed Apr. 29, 2004, which is a 371 application of PCT/US2004/013666 filed Apr. 29, 2004, which claims priority to U.S. Provisional Application No. 60/511,618 filed Oct. 15, 2003 and U.S. Provisional Application No. 60/466,643 filed Apr. 30, 2003, all of which are incorporated herein by reference in their entirety.

### BACKGROUND OF THE INVENTION

1. Field of the Invention

The present invention relates generally to systems, methods and apparatuses for removing impurities and other undesirable compounds from fluids, and specifically to a method, system and apparatus for removing impurities from wine.

2. Description of Related Art

Wine consumption constitutes an important and prevalent pastime and luxury throughout the world. However, each year, an estimated two to seven percent of all cork-bottled wines are discarded due to contamination commonly referred to as cork-taint. Even at the conservative estimate of two percent, cork-taint is estimated to affect $650 million worth of wine worldwide, and $281 million worth domestically, each year. Cork-taint is a defect that gives finished cork-bottled wine an instantly detectable musty and moldy odor. Specifically, cork-taint is the result of a chemical reaction between the chlorine left in the cork during the sterilization process and the phenols in the wine itself, which results in a compound called trichloroanisole (TCA). Although TCA is harmless, it nonetheless compromises the wine's flavor by affecting the olfactory senses. In some cases, a wine's fruity character is masked with a musty odor. In more severe cases, the characteristic aromas of the wine are completely overpowered by a dank, moldy, earthy and sometimes medicinal odor.

Once contaminated, the wine is undrinkable, since TCA has a very distinctively unpleasant odor even at low concentrations. Still further, other chemical compounds can contaminate wine and impair the drinkability of the wine. These other chemical compounds may be referred to as flaws or faults in the wine. A flaw is a characteristic experienced as a minor departure from an acceptable, normal situation, and one that causes the wine to be atypical and less than normally enjoyable. In comparison, a fault is a characteristic experienced as a major departure from the acceptable, normal situation, and one that spoils the wine and causes it to be significantly atypical, usually unpleasant and often undrinkable. Flaws and faults fall roughly into two groups, those attributable to errors in winemaking technique or cellar management and those attributable to other factors. In the first group are errors such as incorrect sulphiting, failure to top up or check fermentation locks, failure to add nutrients, failure to rack promptly, failing to test for completion of malo-lactic fermentation (MLF), and other similar errors. In the second group are problems over which the winemaker has less or no control, such as cork quality, acetified grapes or brett contamination. A wine with very high or very low acid, inappropriate sweetness or a wine that is currently undrinkable due to overpowering tannin is exhibiting a flaw. There are many compounds that lead to such flaws or faults, such as reduced sulfur compounds, acetaldehyde, MLF in bottled wine, yeast fermentation in bottled wine, ethyl acetate, inadequate settling of white juice, trichloroanisole, 2,3 ethoxy, 3,4 hexadiene (geranium), candida-acetaldehyde, volatile acidity including acetic acid and ethyl acetate, diacetyl, brettanomyces contamination, chemical contaminants and additive overuse (i.e., sorbate, etc.).

Presently, there is no solution to the issue of cork-taint, contamination flaws and faults in the wine and, therefore, any affected wine is discarded and wasted. Some wine producers are attempting to switch from natural corks to other types of closures. However, since the vast majority of wineries, particularly high-end vintners, do not want to abandon the real cork for synthetic alternatives, incidents of cork-taint and other contaminants in the finished wine product are inevitable. In addition to using different enclosure devices, other attempted solutions involve fumigating the cork. See, for example, U.S. Pat. Nos. 6,152,966; 6,348,243; 6,316,511; 6,221,450; 6,221,451; 6,216,897; 5,975,322; 5,947,310; 5,904,965; 5,662,233; 5,352,417; 5,174,956; 4,812,317; and 4,042,543. However, none of these prior art methods and systems relate to rescuing the wine itself.

### SUMMARY OF THE INVENTION

It is, therefore, an object of the present invention to provide a method, system and apparatuses for removing impurities from wine that overcome the deficiencies of the prior art. It is another object of the present invention to provide a method, system and apparatuses for removing impurities from wine that does not detrimentally affect the taste components of the remaining wine. It is a still further object of the present invention to provide a method, system and apparatuses for removing impurities from wine that uses an apparatus that is simple in construction and easy to use by a typical consumer. It is a still further object of the present invention to provide a method, system and apparatuses for removing impurities from wine using low maintenance and effective components.

In a first preferred and non-limiting embodiment, the present invention is directed to an impurity removal system for wine. The system includes a filtered wine container defined by a collection portion. The filtered wine container includes an opening for introducing the wine to the collection portion. A filtration device is in operable communication between a wine source and the container, such that at least a portion of the wine introduced from the wine source is in fluid communication with the filtration device prior to collection in the collection portion of the filtered wine container. In operation, the wine is removed from the wine source, introduced to the system, passed through the filtration device and filtered wine flows into the collection portion of the filtered wine container.

In one preferred and non-limiting embodiment, the system also includes a pressure mechanism having an internal fluid passageway with a wine entry portion and a filtered wine exit portion. The filtration device is in fluid communication with the internal fluid passageway and positioned between the wine entry portion and the filtered wine exit portion. In operation, the pressure mechanism urges the wine from the wine source through the entry portion, further through the filtration device, out of the exit portion, through the filtered wine container opening and into the collection portion. The pressure mechanism may include a gas entry opening in fluid communication with the wine source and a pump mechanism for injecting gas into the wine source through the gas entry opening. This injection of gas, typically air, urges wine from the wine source into the unfiltered wine entry portion of the pressure mechanism. The filtration device may include a filter medium, such as activated carbon. The activated carbon can be positioned in a holder device that allows wine to pass therethrough, such as a bag, a disk, a pouch, a fabric container, a container with perforated walls, etc.

In another preferred and non-limiting embodiment, the filtration device is positioned between the opening in the collection portion of the container. Further, the filtration device includes a filter housing in operable communication with a filter medium, and the filter housing is sized and shaped so as to be removably engageable between the opening in the collection portion of the container. In order to draw wine through the filtration device, a vacuum mechanism may also be used.

The present invention is also directed to a method for removing an impurity from wine. This method includes the steps of: (a) introducing wine through a filtration device having a filter medium; (b) filtering, by the filter medium, the wine as it passes through the filtration device; and (c) collecting the filtered wine in a container.

The present invention is also directed to an apparatus for removing impurities from wine for use in connection with a wine source at least partially filled with wine. The apparatus includes a filtration device in operable communication with a wine source and having a filter medium for filtering wine introduced from the wine source. Accordingly, at least a portion of the wine introduced from the wine source is in fluid communication with a filtration device. The filter medium is capable of removing one or more impurities from the wine introduced from the wine source.

The present invention, both as to its construction and its method of operation, together with the additional objects and advantages thereof, will best be understood from the following description of exemplary embodiments when read in connection with the accompanying drawings.

### BRIEF DESCRIPTION OF THE DRAWINGS

FIG. 1 is a schematic view of a preferred embodiment of an impurity removal system for wine according to the present invention;

FIG. 2 is a schematic view of a further preferred embodiment of an impurity removal system for wine according to the present invention;

FIG. 3 is a side sectional and schematic view of a preferred embodiment of the impurity removal system for wine according FIG. 2 in operation;

FIG. 4 is a perspective view of a further preferred embodiment of a neck-engaging portion of an impurity removal system for wine according to the present invention;

FIG. 5 is an exploded, perspective view of the neck-engaging portion of FIG. 4;

FIG. 6 is a side sectional view of the neck-engaging portion of FIG. 4;

FIG. 7 is an exploded side view of a further preferred embodiment of an impurity removal system for wine according to the present invention; and

FIG. 8 is a schematic view of the impurity removal system for wine of FIG. 7 in operation.

### DESCRIPTION OF THE PREFERRED EMBODIMENTS

For purposes of the description hereinafter, the terms “upper”, “lower”, “right”, “left”, “vertical”, “horizontal”, “top”, “bottom” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

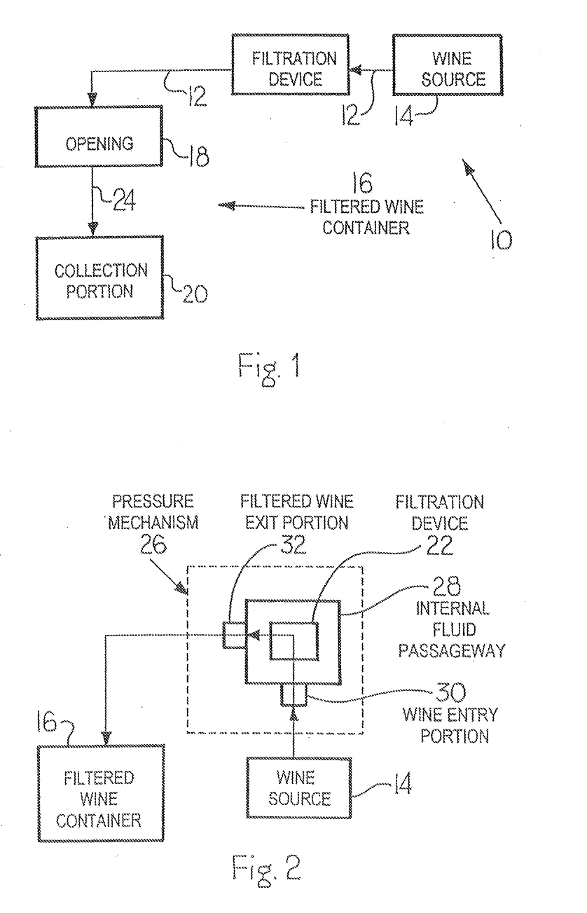

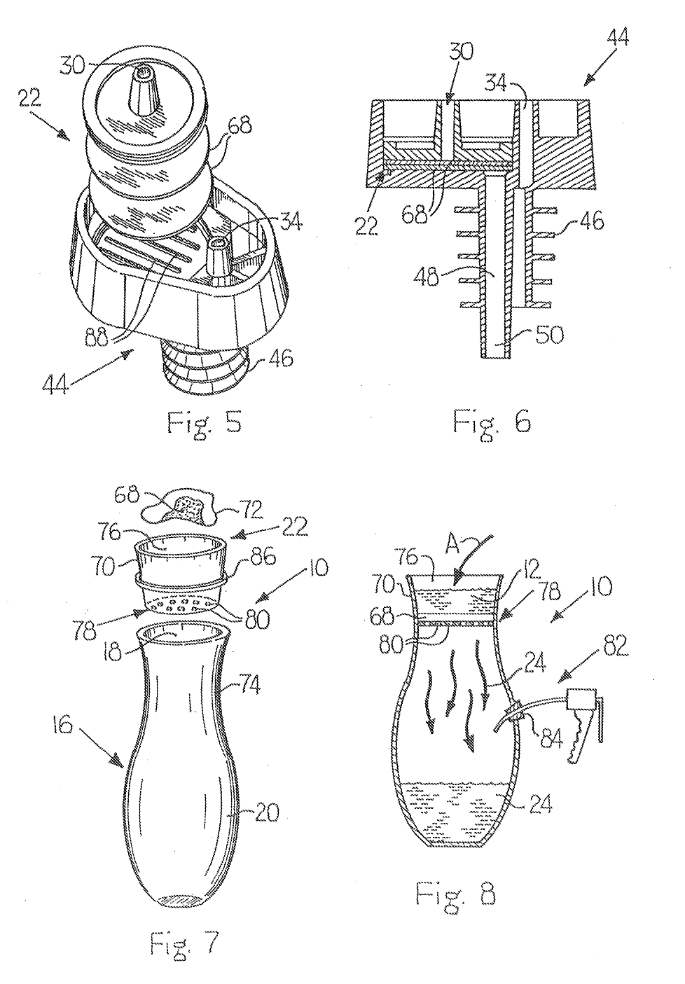

The present invention is directed to an impurity removal system 10 for use in connection with a fluid, typically wine 12, as seen in various embodiments and modes of operation in FIGS. 1-8. The wine 12 is introduced to the system 10 from a wine source 14, which is typically a wine bottle or other wine container as is known in the art. In one preferred embodiment, the system 10 includes a filtered wine container 16, and the filtered wine container 16 includes an opening 18 and a collection portion 20. In addition, a filtration device 22 is in operable communication between the wine source 14 and the container 16, such that at least a portion of the wine 12 introduced from the wine source 14 is in fluid communication with the filtration device 22 prior to collection in the collection portion 20 of the filtered wine container 16. In operation, the wine 12 is removed from the wine source 14, introduced to the system 10, passed through the filtration device 22 and filtered wine 24 flows into the collection portion 20 of the filtered wine container 16. The filtration device 22 allows for the contact adsorption or absorption of certain impurities absorbed or dispersed in the wine 12. Therefore, when the wine 12 is introduced to the filtration device 22, the wine 12 is filtered, which operates to remove such impurities.

In one preferred and non-limiting embodiment, and as illustrated in FIG. 2, the system 10 may include a pressure mechanism 26 having one or more internal fluid passageways 28. The internal fluid passageway 28 includes a wine entry portion 30 and a filtered wine exit portion 32. In this embodiment, the filtration device 22 is in fluid communication with or positioned within the internal fluid passageway 28 of the pressure mechanism 26, specifically between the wine entry portion 30 and the filtered wine exit portion 32. In operation, the pressure mechanism 26 urges the wine 12 from the wine source 14 through the wine entry portion 30, further through the filtration device 22, out of the filtered wine exit portion 32, through the filtered wine container opening 18 and into the collection portion 20 of the container 16. In this mode of operation, the pressure mechanism 26 serves to pressurize, such as by gas or fluid, the wine source 14, typically a wine bottle. Such pressure forces the wine 12 through the system 10 and into the filtered wine container 16. As used herein, the term “urges” means to push, pull, pressure, force, draw or otherwise facilitate the transfer of a material, such as the wine 12.

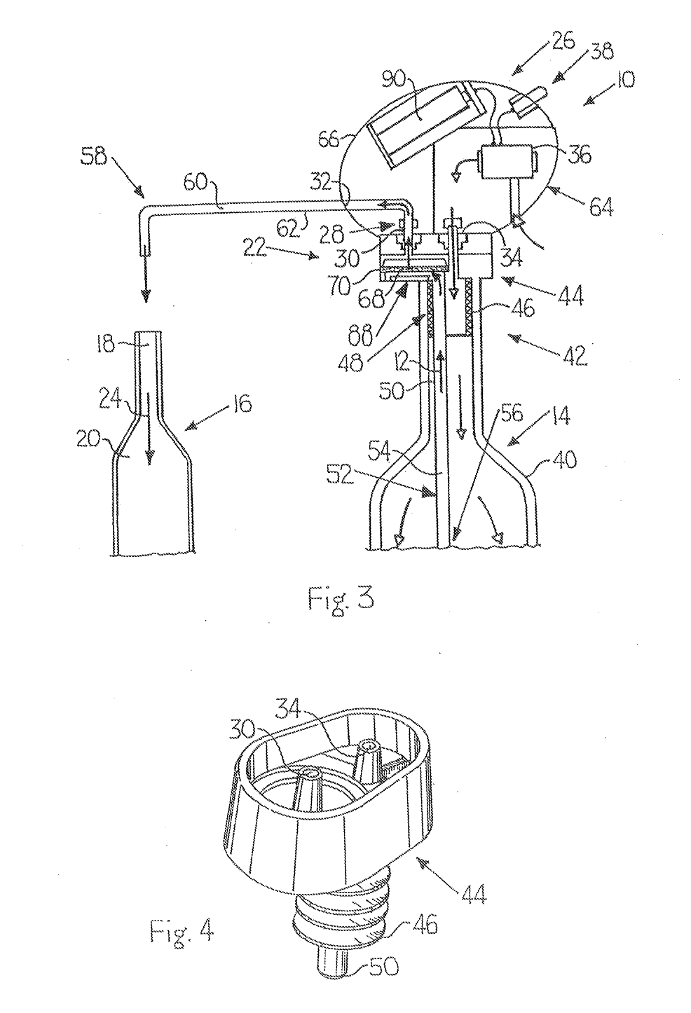

A preferred embodiment of the pressure mechanism 26 used in connection with the system 10 is illustrated, in operation, in FIG. 3. In this embodiment, the pressure mechanism 26 also includes a gas entry opening 34 in fluid communication with the wine source 14. In addition, the pressure mechanism 26 includes a pump mechanism 36 that is capable of injecting gas into the wine source 14 through the gas entry opening 34. As discussed above, the injection of gas into the wine source 14 through the gas entry opening 34 pressurizes the wine source 14 and urges the wine 12 from the wine source 14 into the wine entry portion 30 of the pressure mechanism 26. In a preferred embodiment, the gas is air, and the pump mechanism is a powered air pump. In order to effect appropriate operation of the air pump, this pump must be capable of drawing air from an area outside the pressure mechanism 26, typically through some access port or air entryway.

An actuation mechanism 38 is provided and is in operable communication with the pump mechanism 36. The actuation mechanism 38 is configured to power the pump mechanism 36 “ON” and/or “OFF”. This allows the user to effectively begin the pressurization process and, when the filtration is complete, power the pump mechanism 36 “OFF”. In one preferred embodiment, the actuation mechanism 38 is a push-button assembly that is engageable and actuatable by a user between various operating conditions.

As set forth above, the wine source 14 is typically a wine bottle 40 having a neck portion 42. Accordingly, the pressure mechanism 26 may also include a neck-engaging portion 44 capable of frictionally engaging the neck portion 42 of the wine bottle 40. Various views of the neck-engaging portion 44 are illustrated in FIGS. 4-6. The neck-engaging portion 44 engages the neck portion 42 of the wine bottle 40 and creates an airtight seal between an internal portion of the wine bottle 40 and an outside atmosphere in order to compliment such airtight engagement, the neck-engaging portion 44 may also include a seal element 46 that extends around a surface of the neck-engaging portion 44. The seal element 46 effectively seals the neck-engaging portion 44 within the neck portion 42 of the wine bottle 40 in an airtight manner. The seal element 46 may be a gasket, a plurality of ridges or other similar seal mechanisms as is known in the art. In addition, the seal element 46 may be made from any suitable material that allows the neck-engaging portion 44 to engage and seal within the neck portion 42 of the wine bottle 40.

In this embodiment, the neck-engagement portion 44 includes an internal fluid passageway 48 having an unfiltered wine entry portion 50. The internal fluid passageway 48 of the neck-engaging portion 44 is in fluid communication with the internal fluid passageway 28 of the pressure mechanism 26. In this manner, fluid communication between the wine bottle 40 and the internal fluid passageway 28 of the pressure mechanism 26 is achieved. In this embodiment, the filtration device 22 is positioned within the internal fluid passageway 48 of the neck-engaging portion 44. In this manner, and in operation, wine 12 is introduced from wine source 14 through the unfiltered wine entry portion 50 of the neck-engaging portion 44, contacts the filtration device 22 positioned within the neck-engaging portion 44 and continues through the wine entry portion 30 of the pressure mechanism 26 and out the filtered wine exit portion 32. The neck-engaging portion 44 may be considered integral with or removable from the pressure mechanism 26, however the pressure mechanism 26 is intended to embody the various components and subcomponents of the system, including the filtration device 22, the pump mechanism 36, the actuation mechanism 38 and the neck-engaging portion 44. In addition, these various components may be individually manufactured and engaged and fitted after the manufacturing process. For example, the filtration device 22 may be clamped within or frictionally engaged in the internal fluid passageways.

A dip tube 52, which includes an internal fluid passageway 54, may also be provided. The dip tube 52 includes an unfiltered wine entry portion 56, and the internal fluid passageway 54 of the dip tube 52 is in fluid communication with the internal fluid passageway 48 of the neck-engaging portion 44. Further, the dip tube 54 may be removably connectable to the neck-engaging portion 44. In operation, when air is forced into the wine bottle 40, the wine 12 passes up the internal fluid passageway 54 of the dip tube 52 and into the internal fluid passageway 48 of the neck-engaging portion 44, where it contacts the filtration device 22. After contact with the filtration device 22, the filtered wine 24 moves through the internal fluid passageway 28 of the pressure mechanism 26 and out of the filtered wine exit portion 32, as discussed in detail above.

The pressure mechanism 26 may also include an exit tube 58 having an internal fluid passageway 60 with a filtered wine entry portion 62. The internal fluid passageway 62 of the exit tube 58 is in fluid communication with the filtered wine exit portion 32 of the pressure mechanism 26. In addition, it is envisioned that the exit tube 58 is shaped such that it can be positioned above the opening 18 of the filtered wine container 16. See FIG. 3. In operation, the filtered wine 24, which has already been processed by the filtration device 22, passes through the filtered wine exit portion 32 into the filtered wine entry portion 62 of the exit tube 58, through the internal fluid passageway 60 and flows into the filtered wine container 16.

The pressure mechanism 26 may also include a pressure mechanism housing 64. This housing 64 may extend around the various components and subcomponents of the pressure mechanism 26, including the neck-engaging portion 44, or alternatively, the neck-engaging portion 44 may be removably attachable to the pressure mechanism housing 64. It may be desirable to allow the neck-engaging portion 44 to be removable from the housing 64, such that the filtration device 22 can be easily maintained. In this embodiment, the pump mechanism 36 is positioned within the housing 64, and the housing 64 includes a wall 66. The wine entry portion 30 is an opening that extends through the wall 66 of the housing 64 and is in fluid communication with the internal fluid passageway 28 of the pressure mechanism 26. Similarly, the filtered wine exit portion 32 is an exit opening that also extends through the wall 66 of the housing 64 and is in fluid communication with the internal fluid passageway 28 of the pressure mechanism 26.

The filtration device 22 includes a filter medium 68, which is typically surrounded by a filter housing 70. In a preferred embodiment, the filter housing 70 surrounds the filter medium 68, and the filter housing 70 is sized and shaped so as to be removably engaged within the internal fluid passageway 28 of the pressure mechanism 26 and/or the internal fluid passageway 48 of the neck-engaging portion 44.

In a preferred embodiment, the filter medium 68 is activated carbon, and the activated carbon can be positioned in the holder device 72. This holder device 72 can be a bag, a disk, a pouch, or some other fabric container that allows the wine 12 to pass therethrough. For example, the holder device 72 can be a perforated fabric container or netted structure. However, it is also envisioned that the filter medium 68 can be in the form of a solid or semi-solid block of activated carbon that is simply rested in a specific area in the internal fluid passageway (28, 48). In addition, the filter medium 68 can be chipped or granulated activated carbon that is simply positioned or placed directly in the desired area, provided that the granulated activated carbon does not inadvertently move through the system 10 and out with the filtered wine 24. Therefore, it is typically preferred to use some sort of a contained holder device 72, which allows for easy removal and disposal and tends to be less messy. It is also envisioned that the filter medium 68 includes multiple layers, each comprising the filter medium 68. For example, the filter medium 68 may include a layer of carbon paper, a layer of carbon filter, a layer of activated carbon and/or a further layer of carbon paper. In addition, the filter medium may include a cloth layer and/or a carbon-impregnated paper. Any appropriate filter medium 68 layer variation and construction is envisioned, such that the filter medium 68 removes the undesirable compounds of the unfiltered wine 12. The filter medium 68 is selected such that one or more impurities can be removed from the wine 12, such as trichloroanisole, an odor compound, a chemical compound, etc.

A further preferred and non-limiting embodiment is illustrated in FIGS. 7 and 8. In this embodiment, the filtration device 22 includes a filter medium 68 positioned within a holder device 72, and a filter housing 70 sized and shaped so as to be removably engaged between or within the opening 18 of the filtered wine container 16. Specifically, the container 16 may include a neck portion 74 that connects the opening 18 to the collection portion 20. The filter housing 70 is positioned in this neck portion 74. As best seen in FIG. 7, the filtered wine container 16 can be in the shape of a carafe, which has a tapered neck portion 74. Therefore, the filter housing 70 is similarly tapered so as to be removably inserted and engaged within the neck portion 74.

Further, in this embodiment, the filter housing 70 includes a filter housing opening 76 and a filter housing base surface 78. The filter housing opening 76 allows the wine 12 that is introduced from the wine source 14 to pass through the opening 18 of the container 16 and enter the filter housing 70 via the filter housing opening 76. In addition, the filter housing base surface 78 serves two purposes, namely to support the filter medium 68 in the filter housing 70 and to allow the wine 12 that is filtered through the filter medium 68 to pass through the filter housing base surface 78 into the collection portion 20. Therefore, the filter housing base surface 78 may include one or more base surface orifices 80 and allow for the passage of wine therethrough. For example, the base surface orifices 80 may simply extend through the filter housing base surface 78 and can be positioned throughout the base surface 78. It is also envisioned that mesh, perforation, a support ledge or other manner of supporting the filter medium 68, yet allowing the passage of wine therethrough, are envisioned.

As seen in FIG. 8, in operation, unfiltered wine 12 is poured into the opening 18 of the container 16, as indicated by arrow A. This unfiltered wine 12 enters the filter housing 70 through the filter housing opening 76 and contacts the filter medium 68 resting upon the filter housing base surface 78. Using gravity or other methods described hereinafter, the unfiltered wine 12, after contacting the filter medium 68, moves through the filter housing base surface 78, and specifically the base surface orifices 80. In this manner, filtered wine 24 enters the collection portion 20 of the container 16 and is collected for future decanting. After the unfiltered wine 12 has been treated and becomes filtered wine 24, the filtration device 22 can be removed from the neck portion 74 of the container 16 and the container 16 can be used to serve, store or otherwise transfer the filtered wine 24 to various other containers or glasses.

In this embodiment, simply pouring the unfiltered wine 12 into filtration device 22 and allowing the wine to flow through the filter medium 68, through the base surface orifices 80 and into the collection portion 20, the system 10 is relying on gravity. Allowing the system 10 to rely on gravity to move the unfiltered wine throughout the filtration device 22 is a time consuming and laborious process. The operator must continually pour small amounts of the unfiltered wine 12 into the filtration device 22 and wait for the unfiltered wine 12 to flow through the filter medium 68 and further through the base surface orifices 80 and into the collection portion 20.

Accordingly, the system 10 can also include a vacuum mechanism 82 in operable communication with the collection portion 20 of the container 16. This vacuum mechanism 82 draws the unfiltered wine 12 introduced into the opening 18 through the filtration device 22 and into the collection portion 20. In order to communicate with the collection portion 20, the collection portion 20 may also include a vacuum orifice 84 extending through a container wall and into the collection portion 20 of the container 16. The vacuum mechanism 82 would include appropriate components to attach to the vacuum orifice 84, thereby allowing the air to be evacuated from the collection portion 20, such that the unfiltered wine 12 would be more quickly pulled through the filtration device 22 into the collection portion 20.

In order to complete the vacuum seal of the collection portion 20, the filtration device 22, and specifically the filter housing 70, includes a filter housing seal 86 extending around an outside surface of the filter housing 70. In one preferred and non-limiting embodiment, the filter housing seal 86 is in the form of a pliant rubber ring that extends around the filter housing 86. In operation, the filter housing 86 is lodged in the neck portion 74 of the container 16, with the filter housing seal 86 engaging against the neck portion 74. This effectively seals the collection portion 20 of the container 16 and provides a chamber that the vacuum mechanism 82 can evacuate.

In one preferred and non-limiting embodiment, the vacuum mechanism 82 is a hand pump having a handle and a vacuum tube connected to the vacuum orifice 84 of the container 16. When the handle portion of the hand pump is actuated, a vacuum is pulled on the collection portion 20 by pulling the air in the collection portion 20 through the vacuum tube. This will then draw the unfiltered wine 12 through the filtration device 22. In order to ensure a proper seal between the hand pump 46 and the container 16, a tapered rubber stopper having a tube passageway extending through the stopper can be used. The vacuum tube is threaded through the tube passageway of the stopper, and the stopper is inserted partially within and engaged with the vacuum orifice 84. The stopper serves to seal the vacuum orifice and allows the collection portion of the container to be in operable communication with the vacuum mechanism 82.

The filtration device 22, including the filter housing 70 and the filter medium 68, can be used in connection with any appropriately sized and shaped container 16 or other component, such as the pressure mechanism 26 or neck-engaging portion 44. Various sizes and shapes of the filter housing 70, holder device 72 and filter medium 68 are envisioned. When the filter medium 68 is housed in the holder device 72, once the filter medium 68 is spent and needs to be replaced, the operator may simply remove and throw away the holder device 72 and replace it with a refreshed or new holder device 72, while reusing the filter housing 70.

The aforementioned pressure mechanism 26, and specifically the pump mechanism 36 within the pressure mechanism 26, can be any number of different pumps. As opposed to the above-discussed air pump, the pump mechanism 36 may also be a syringe pump, a direct-wired pump, a chemical or liquid dispenser pump, and these pumps may be either manually or power operated. It is desirous to allow the unfiltered wine 12 to move, via pressure, through the filter medium 68 of the filtration device 22 and pass to the collection portion 20 of the container 16. This system 10 can be used to remove any number of impurities from the unfiltered wine 12. For example, running the unfiltered wine 12 through the filter medium 68 removes such undesirable compounds, thus yielding the filtered wine 24 as a desirable product.

The present invention is also directed to a method of removing an impurity from unfiltered wine 12. This method includes the steps of: introducing the unfiltered wine 12 to the filtration device 22, which includes a filter medium 68; filtering, by the filter medium 68, the unfiltered wine 12 as it passes through the filtration device 22; and collecting the filtered wine 24 in the container 16. This method can employ a system 10 as described above.

Further, with respect to the above-discussed pressure mechanism 26, since a process works under many different conditions, however, it is desirable to control the contact time, adsorption characteristics of the filter medium 68 and the bed depth of the filter medium 68. These parameters are unique to the system 10, as the system 10 may preferably operate in a thin-layer adsorption environment, so as to selectively remove the impurities while not removing the desired components of the wine as well, which would be absorbed if not done under the control conditions. Further, when using the pressure delivery aspect of the system 10, the filter medium 68 must provide sufficient backpressure to allow for even spreading of the wine 12 through the medium 68. In this manner, one or more baffles 88 can be provided in a position adjacent the filter medium 68, such as in the internal fluid passageway 48 of the neck-engaging portion 44 or the internal fluid passageway 28 of the pressure mechanism 26. These baffles 88 allow the wine 12 to spread and evenly move through the filter medium 68.

The present invention is also directed to an apparatus for removing the impurities from the wine 12. This apparatus includes the filtration device 22, which includes the filter medium 68. This filtration device 22 must be placed in series between the wine 12 and the wine source 14 and any resulting container 16 for filtered wine 24. As discussed above in connection with the pressure mechanism 26 variation, the pressure mechanism housing 64, together with or integrated with the neck-engaging portion 44, may be produced and sold as a commodity apart from both the wine source 14 and the filtered wine container 16. It is envisioned that a user would provide both the wine source 14 (or wine bottle 40) as well as the filtered wine container 16, such as a carafe or the like. When offering the pressure mechanism 26 variation of the system 10, and in order to power the pump mechanism 36, a battery 90 may be insertable within or positioned within the pressure mechanism housing 64. The battery 90 would provide power to the pump mechanism 36 for injecting air into the wine source 14, or wine bottle 40.

In this manner, the present invention provides a method, system 10 and apparatus that removes undesired impurities from finished wine. Only the undesirable compounds, such as TCA, are removed, while the subtle taste components of the wine remain. The method, system 10 and apparatus allow contaminated and finished wine to be treated as opposed to be discarded and unused. The present invention also provides a method, system 10 and apparatus that removes the undesirable sulfites from the wine and eliminates the problems associated with the sulfites.

This invention has been described with reference to the preferred embodiments. Obvious modifications and alterations will occur to others upon reading and understanding the preceding detailed description. It is intended that the invention be construed as including all such modifications and alterations.

The invention claimed is:

1. An impurity removal system for purifying wine removable from a wine source, comprising:
a filtered wine container defined by a collection portion and having an opening for introducing the wine to the collection portion; and
a filtration device in operable communication between the wine source and the container, such that at least a portion of the wine introduced from the wine source is in fluid communication with the filtration device prior to collection in the collection portion of the filtered wine container;
wherein, in operation, the wine is removed from the wine source, introduced to the system, passed through the filtration device and filtered wine flows into the collection portion of the filtered wine container.

2. The system of claim 1, further comprising:
a pressure mechanism having at least one internal fluid passageway having an wine entry portion and a filtered wine exit portion;
wherein the filtration device is in fluid communication with the internal fluid passageway between the wine entry portion and the filtered wine exit portion;
wherein, in operation, the pressure mechanism urges the wine from the wine source through the entry portion, through the filtration device, out of the exit portion, through the filtered wine container opening and into the collection portion.

3. The system of claim 2, wherein the pressure mechanism further comprises:
a gas entry opening in fluid communication with the wine source; and
a pump mechanism configured to inject gas into the wine source through the gas entry opening, thereby urging wine from the wine source into the unfiltered wine entry portion of the pressure mechanism.

4. The system of claim 2, wherein the wine source is a container with a neck portion, wherein the pressure mechanism further comprises a neck-engaging portion configured to frictionally engage the neck portion of the wine source container.

5. The system of claim 2, wherein the pressure mechanism further comprises an exit tube having an internal fluid passageway with a filtered wine entry portion, the internal fluid passageway of the exit tube in fluid communication with the filtered wine exit portion.

6. The system of claim 2, wherein the pressure mechanism and the filtration device are positioned within a housing having a wall, the wine entry portion comprising an entry opening extending through the wall of the housing and in fluid communication with the internal fluid passageway, and the filtered wine exit portion comprising an exit opening extending through a wall of the housing and in fluid communication with the internal fluid passageway.

7. The system of claim 2, wherein the filtration device includes a filter medium configured to remove at least one impurity from the wine introduced from the wine source container.

8. The system of claim 1, wherein the filtration device includes a filter medium configured to remove at least one impurity from the wine removed from the wine source.

9. The system of claim 1, further comprising a vacuum mechanism in operable communication with the collection portion of the container and configured to draw the wine introduced into the opening through the filtration device and into the collection portion.

10. The system of claim 9, wherein the filtration device includes a filter housing having a filter housing seal in operable communication with the filter housing and configured to sealingly engage the filter housing in the container.

11. A method of removing an impurity from wine, comprising the steps of:
(a) introducing wine to a filtration device having a filter medium;
(b) filtering, by the filter medium, the wine as it passes through the filtration device; and
(c) collecting the filtered wine in a container.

12. The method of claim 11, wherein the filter medium is activated carbon.

13. The method of claim 12, wherein the activated carbon is positioned within a holder device configured to allow the wine to pass therethrough.

14. The method of claim 13, wherein the holder device is at least one of a bag, a disk, a pouch, a fabric container and a container with perforated walls.

15. The method of claim 11, further comprising the step of drawing the wine through the filter medium using at least one of a vacuum mechanism and a pressure mechanism.

16. An apparatus for removing an impurity from wine for use in connection with a wine source at least partially filled with wine, the apparatus comprising a filtration device in operable communication with the wine source and having a filter medium configured to filter wine introduced from the wine source, such that at least a portion of the wine introduced from the wine source is in fluid communication with the filtration device; wherein the filter medium is capable of removing at least one impurity from the wine introduced from the wine source.

17. The apparatus of claim 16, wherein the filter medium is activated carbon.

18. The apparatus of claim 17, wherein the activated carbon is positioned within a holder device configured to allow the wine to pass therethrough.

19. The apparatus of claim 18, wherein the holder device is at least one of a bag, a disk, a pouch, a fabric container and a container with perforated walls.

20. The apparatus of claim 16, wherein the wine is drawn through the filtration device by at least one of a vacuum mechanism and a pressure mechanism.
